(19) United States
(12) Patent Application Publication
(10) Pub. No.: US 2004/0251837 A1
(43) Pub. Date: Dec. 16, 2004

(54) Motion sequence detection and actuation circuitry and articles incorporating same

(75) Inventors: Kwok Lung Leung, Kowloon (CN); Kwok Piu Aaron Yeung, Kowloon (CN)

Correspondence Address: BURNS, DOANE, SWECKER & MATHIS, L.L.P., P.O. Box 1404, Alexandria, VA, 22313-1404, US

(73) Assignee: Kwok Lung Leung, Kowloon (CN)

(21) Appl. No.: 10/457,364

(22) Filed: Jun. 10, 2003

(51) Int. Cl. H01K 7/00; H05B 37/02

(52) U.S. Cl. 315/76; 315/209 R; 362/500

(57) ABSTRACT

A circuit arrangement including a contact switch, a motion dependent switching means and motion detection means, said contact switch being alternatively movable between a first switching position and a second switching position corresponding to the alternative first and second making (or breaking) positions, said motion detection means include means to generate an actuation signal when said motion dependent switching means moves between said first and said second switching positions according to a first predetermined sequence and within a first predetermined time.

### FIELD OF THE INVENTION

This invention relates to motion actuatable circuit arrangements and articles incorporating same. More particularly, this invention relates to motion sequence detection and actuation circuitry and articles incorporating same. More specifically, although of course not solely limited thereto, this invention relations to motion sequence actuated light pattern generating circuitry and articles incorporating same.

### BACKGROUND OF THE INVENTION

Motion actuated circuit arrangements have been widely used in consumer electronics and consumer articles. For example, light pattern generating circuit arrangements have been employed in shoes so that prescribed light patterns will be generated upon detection of motion. Similarly, light emitting circuit arrangements have been included in toys such as skating boards, yoyos and tops so that appropriate light patterns are generated when motion reaching a prescribed speed has been reached.

However, prior art circuit arrangements for light pattern generating in consumer articles provide very limited information on the actuating motion and are substantially cosmetic in nature. Hence, it is desirable if there can be provided circuit arrangements, especially circuit arrangements suitable for consumer article applications, and articles incorporating same with additional or useful information relating to the actuating motion,

Furthermore, conventional light pattern generating circuit arrangements usually require a plurality of power sources of different voltages to cater for the different voltage requirements of a variety of LEDs, thereby requiring additional batteries and increasing the weight of the articles. Also, conventional light pattern generating circuit arrangements have many shortcomings, for example, that the power sources have a relatively short operating life, the circuit arrangements are vulnerable to damage due to leakage, etc. Hence, it is desirable if shortcomings of conventional light pattern circuit arrangements and articles incorporating same can be alleviated.

### OBJECT OF THE INVENTION

Accordingly, it is an object of the present invention to provide light pattern generating circuit arrangements which provide additional or useful information relating to the actuation motion. More specifically, it is an object of the present invention to provide circuit arrangements indicating a prescribed sequence of motion. It is also an object of the present invention to provide improvements to alleviate shortcomings of conventional light pattern generating circuit arrangements and articles incorporating same. Of course, the above objectives are to be read disjunctively with the minimum of providing the public with a useful choice.

### SUMMARY OF THE INVENTION

According to a first aspect of the present invention, there is provided a circuit arrangement including a contact switch, a motion dependent switching means and motion detection means, said contact switch being alternatively movable between a first switching position and a second switching position corresponding to the alternative first and second making (or breaking) positions, said motion detection means include means to generate an actuation signal when said motion dependent switching means moves between said first and said second switching positions according to a first predetermined sequence and within a first predetermined time.

Preferably, said motion detection means include means for retaining the immediately past switching status of one of said switching positions for a second predetermined time, said second determined time being equal or larger than said first predetermined time.

Preferably, said motion detection means further include comparison means to compare said stored immediately past switching status of said one of said contact switches with the immediately next switching status of the other contact switch, said comparison means generates an actuation signal when said immediately past switching status of said one of said contact switch and said immediately next switching status of the other contact switch fulfil a predetermined relative relationship.

Preferably, said motion detection means includes a NAND gate with one of its input terminals connected to said first switching position and another of its input terminals connected to said second switching position, a capacitive means being connected intermediate between said second input terminal of said NAND gate and said second switching position of said contact switch.

Preferably, the output of said NAND gate is connected to an electronic light pattern generating means which includes a plurality of outputs pre-programmed to give a pre-determined sequence of lighting patterns.

Preferably, said motion dependent switching means includes first, second and third contact terminals and a movable switching member, said movable switching member can provide conductive bridging either over said first and second or said second and third contact terminals, thereby respectively forming said first and second switching positions.

Preferably, said movable switching member includes a conductive sphere movable between said first and second switching positions.

Preferably, said movable switching member includes a conductive cylindrical rod movable between said first and second switching positions.

Preferably, said motion dependent switching means include a cantilever-type switching member which is under spring bias in said first or said second switching positions.

Preferably, said circuit further including a visual display means, said visual display means include a plurality of light emitting diodes of a first and a second, higher, operating voltage and said second operating voltage being provided by a charged capacitor in addition to a common power source.

Preferably, said circuit further including a transparent flexible panel with at least a receptacle for receiving at least one visual display means.

Preferably, said transparent flexible panel include a surface on which there are engraved figures, patterns or lines formed by carbon dioxide laser.

Preferably, said engraved areas include grooves having edges which are substantially perpendicular to the transparent flexible panel surfaces for light reflection.

Preferably, said transparent flexible panel being attached to the outer wall of the shoe.

According to a preferred embodiment of the present invention, there are provided articles including the above-mentioned circuit arrangements.

Preferably, said article includes shoes.

### BRIEF DESCRIPTION OF THE DRAWINGS

Preferred embodiments of the present invention will be explained in further detail below by way of examples and with reference to the accompanying drawings, in which:

FIG. 1 shows an example circuit arrangement for realizing a first preferred embodiment of the present invention,

FIGS. 2a and 2b show the cross-sectional views respectfully of a first and a second example of motion actuatable switches which can be used with the circuit arrangement of FIG. 1,

FIG. 3 shows a schematic diagram of a circuit arrangement for charging a battery for providing power to the circuit arrangement of FIG. 1,

FIGS. 4a and 4b respectively show examples of appropriate pulse forms suitable for driving the light emitting sources for application in the circuit arrangement of FIG. 1,

FIG. 5 shows an example of a comb-shaped separator for use with optical guides employed with the circuit arrangement of FIG. 1,

FIG. 6 illustrates an exemplary use of a preferred embodiment of the present invention in footwear,

FIGS. 7 and 7a respectively show a second and a third circuit arrangement for realizing a further preferred embodiment of the present invention,

FIG. 8 is a schematic equivalent circuit diagram of FIG. 1, and

FIG. 9 is a schematic circuit diagram of the circuit arrangement of FIGS. 7a and 7b.

### DETAILED DESCRIPTION OF THE PREFERRED EMBODIMENTS

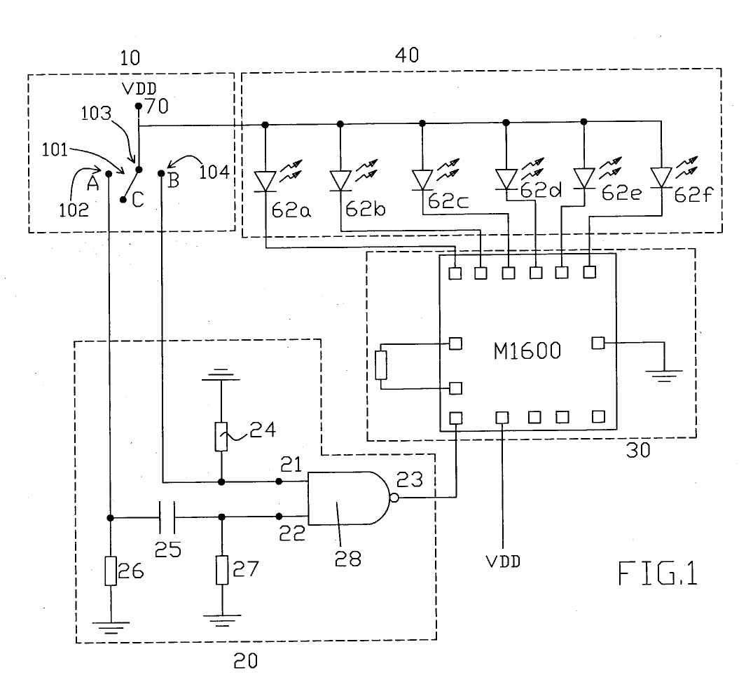

In a first preferred embodiment of the present invention as realized by the circuit arrangement of FIG. 1, there are included a motion actuatable switching means 10, a motion sequence detecting and actuating means 20, a visual display driving means 30 and a plurality of display elements 40.

Referring to the circuit arrangement of FIG. 1, the motion actuatable switching means 10 includes a contact switch having a switching member 101 which is movable between a first switching position (A) and a second switching position (B), corresponding respectively to first and second making positions of the contact switch. The contact switch is opened or in the breaking position when the switching member 101 is intermediate the making positions A and B. Examples of contact switches which are suitable for use as contact switching means in the present invention are shown in 2a and 2b.

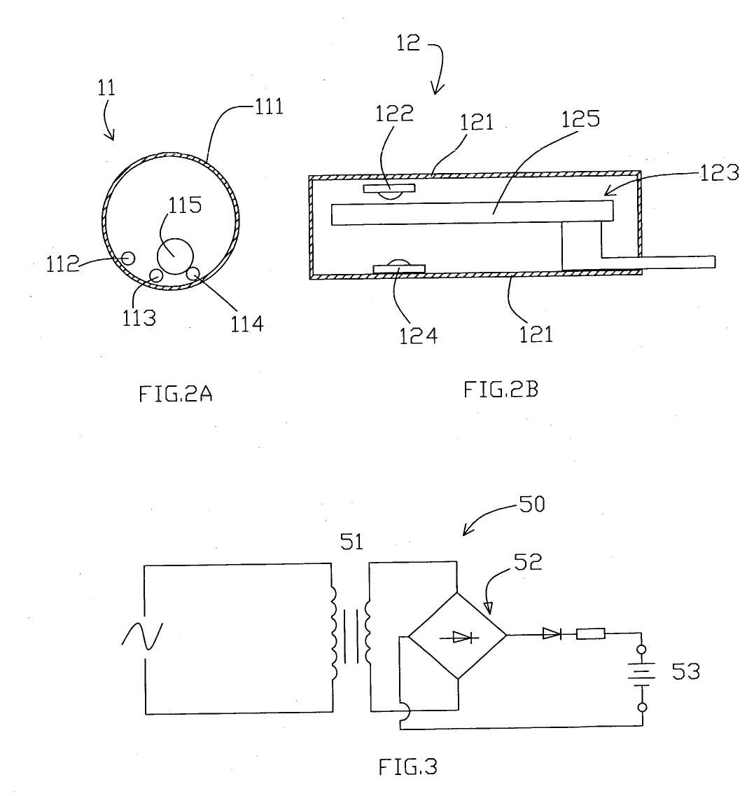

Referring to FIG. 2a, there is shown the transverse cross-section of a first example of an appropriate contact switch 11 which is suitable for use in the present invention. The switch 11 includes a housing 111 on which there are disposed contacts terminal 112, 113, 114 and a movable contact member 115 which is generally conductive or which provides a conductive path between the adjacent pair of contact terminals, that is, contact terminal pairs 112 and 113, or 113 and 114, when the movable contact member 115 bridges across the contact terminals. The contact terminals 112 and 114 correspond respectively to the nodes 102 and 104 of the circuit of FIG. 1 and the contact terminal 113 corresponds to the node 103. The movable contact member 115 can be a conductive sphere or a cylindrical rod made of steel, cooper, graphite or other suitable conductive materials. The housing 111 includes a rounded bottom portion so that the conductive movable contact member 115 can be reciprocally movable between the two switching positions. To restrict undesirable movements, for example, undesirable movement of the contact member directly from the contact terminal 112 over the top of the housing 111 and then to the contact position 114, restricting or limiting means can be provided on the housing, for example, by including a radially inward guard disposed adjacent to the contact terminals 112 and 114 or by linking the contact member 115 to a guarding slot disposed at the rear end of the housing 111.

Referring to FIG. 2b, there is shown the longitudinal cross-section of a second example of an appropriate contact switch 12 which includes a housing 121, first and second contact terminals 122, 124 and a movable cantilever contact member 125 having a free end and a fixed end 123. The free end of the movable cantilever contact member 125 can be reciprocally movable between the contact terminals 122 and 124, corresponding respectively to the first and second alternate switching positions A and B of FIG. 1. The cantilever contact member 125 includes a flexible link with conductive pads or terminals disposed near the front end corresponding to the locations of the contact terminals 122 and 124. Of course, the entire movable member 125 can be made of a resilient and conductive material such as a metallic strip or a conductive rubber strip so that the inherent spring bias will cause the reciprocal motions. The fixed end of the movable contact member 125 includes a conductive member which extends outside the housing 121 of the switch 12 and corresponding to the fixed node 103 of FIG. 1.

FIG. 3 shows the schematic circuit diagram of an example charging circuit suitable for use with the present invention. The charging circuit 50 includes an isolation transformer 51 with primary and secondary windings. The output terminals of the secondary windings are connected to rectifying circuitry 52 the output of which is connected to a rechargeable battery 53. The charging circuit and the rechargeable battery is desirable as the present invention requires operating power, especially power to drive light emitting diodes (LED) such as blue and white LEDs or electrode luminescent (EL), panels, tubes etc. As the electronic circuitry of the present invention is usually permanently concealed within the finished article, it is highly desirable if a recyclable power source is used so that the driving power can be replenished by non-contact charging such as inductive charging through primary and secondary windings which are placed in mutual proximity, such as the windings 51 of the present example. In addition, protective circuitry such as a charging timer and over-voltage protector can be included to avoid overcharging or to prevent fire hazard as well as to extend the operating life of the battery 53.

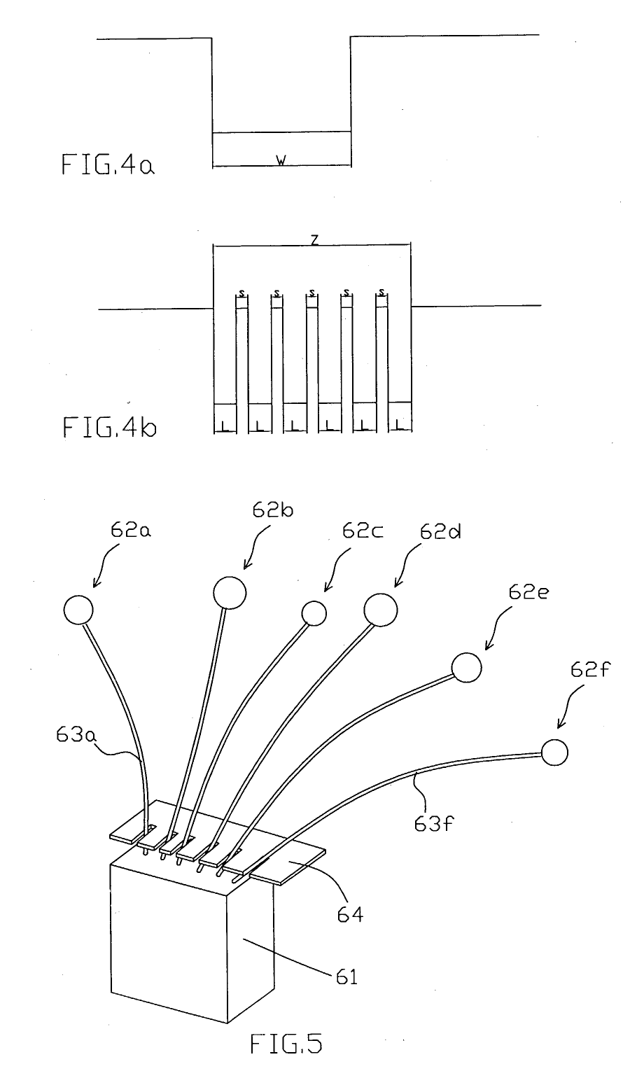

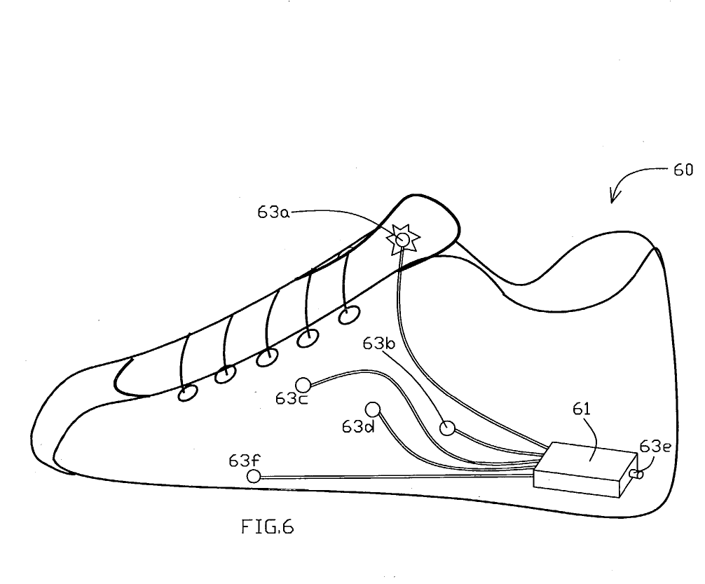

FIGS. 4a and 4b show timing diagrams of two pulse forms which may be used for lighting up the light-emitting devices, such as light emitting diodes (LED), for use with the present invention. The pulse forms in FIGS. 4a and 4b have the same power consumption as the pulses have the same signal magnitude and the aggregate of the time are the same. However, as the entirety of the pulse of FIG. 4b extends over a longer period of time, it may appear to be brighter to a viewer.

FIG. 5 shows an additional accessory that can be used in a preferred embodiment of the present invention. Referring to FIG. 5, an embodiment of a circuit arrangement of the present invention is enclosed in a housing 61 with a plurality of light emitting members 62a-f connected to the circuit arrangement via corresponding conductive wires 63a-f so that this sub-assembly can be supplied as a module for installation in an article. As the articles incorporating this sub-assembly are likely to be used outdoors, moisture, condensation or other damaging fluid may enter the circuit arrangement inside the housing 61 via the wires 63a-f. To alleviate moisture or fluid penetration into the circuit arrangements, a blocking means 64 is disposed intermediate between the light emitting members 62a-f and the entrance to the housing 61. The blocking means includes a saw- or comb-shaped separator having a base plate and a plurality of indentations for receiving the conductive wires 63a-f. After the conductive wires 63a-f have been received in the indentations or slots on the base plate, the slots are then filled with a water-proof filler, such as silicone or other appropriate fillers. This blocking means will serve as a moisture or fluid separator between the light emitting members 62a-f and the electronic circuitry stored within the housing 61 to alleviate the risk of damage to the electronic circuitry by excessive moisture.

FIG. 6 shows an example embodiment of the utilization of the sub-assembly of FIG. 5 in sports shoes. Referring to FIG. 6, the main housing 61 of the sub-assembly containing the electronic circuitry is installed in the heel of a shoe 60. The light emitting members 63a-f are disposed on the outer surface of the shoe and the corresponding conductive wires are hidden or concealed between the fabric walls of the shoes.

The light emitting elements 63a-f can be distributed and mounted on various positions on a transparent and flexible PVC panel attached to the outer wall of the shoes. The flexible PVC member may include a surface on which there are engraved figures, patterns or lines by carbon dioxide laser so that light beams originating from an LED can be transmitted and reflected through the engraved areas thereby creating an aesthetically pleasing light pattern. In general, the engraved areas include grooves having edges which are substantially perpendicular to the flexible PVC surfaces for light reflection. Furthermore, in order to allow maximal light reflection along the engraved troughs or grooves in the flexible PVC panel, at least an LED is mounted near the edge of the PVC panel.

Turning to the circuit arrangement of FIG. 1 and with particular reference to the motion sequence detecting and actuating means 20. The motion sequence detecting and actuating means 20 includes a first input 21, a second input 22 and an output 23. The first input 21 includes means to detect the instantaneous switching condition or state of the contact terminal 104 and is tied to the circuit ground or common via a resistor 24. The second input is connected to the contact terminal 102 and include means to remember the last switching state of the contact terminal 102. This state-holding or memory configuration is implemented in the present embodiment through the use of a capacitor 25 which is in serial connection between the input node 22 and the terminal contact 102. Resistors 26 and 27 are connected from the two terminals of the capacitor to the circuit ground or common. Of course, it will be appreciated that the state-holding arrangement can also be realized by using other forms of R-C arrangements such as a parallel connection of a capacitor and a resistor at the input node 22 to the circuit ground. The operation of this motion sequence detecting and actuating means 20 will be described below with reference to the motion actuatable switching means 10.

As mentioned above, the motion actuatable switching means can move between a first switching position (A) and a second switching position (B). Assuming that the switching member 101 starts at the making position A (i.e. VDD is connected to position A and input node 22 via the capacitor 25. The input node 22 will be tied high (Hi) and will remain in the Hi-state for a prescribed time which is dependent on the RC constant of this circuit path. Next, if the switching member 101 moves to the switching position B within a prescribed time (τ), the input node 21 and 22 will both be Hi and the output 23 of the NAND gate 28 will be “Lo”. On the other hand, if the switching movement of the switching member 101 requires a time longer than τ, the state at input node 22 will be Lo at the time when the input node 21 turns Hi, thereby giving a Hi input at the output node 23.

Turning to the next operating mode, assuming that the switching member 101 starts at the making position B, the input node 21 of the NAND gate will be pulled Hi. When this switching member 101 is moved on to the next making position A, the input node 22 will be pulled Hi. However, at this time, because of the discharge through the resistor 24 (or because there is no capacitor connected to the input node 21), the input node 21 will have been pulled Lo, thereby giving a “Hi” high output at the output node 23, regardless whether the switching movement is completed within or exceeding the prescribed time τ. Hence, it will be appreciated that the NAND gate will give a Lo output only if the switching member 101 moves from the making position A to the making position B within the prescribed time τ. Hence, a “Lo” output of the NAND gate will be indicative of the specific movement of the switching member 101 from the making position A to the making position B within a prescribed time and not vice versa. By utilizing this circuit characteristic, a motion sequence detecting and actuating means can be achieved.

Referring to the circuit arrangements, the output of the motion sequence detecting and actuating means 20 is connected to a visual display driving means 30 which includes, for example, a light flashing driver, such as, the integrated circuit M1600 of “MoslDesign Semiconductor Corp.” of Taiwan. Upon detection of a prescribed actuation signal, which is “Lo” for the present embodiment, the light flashing driver Ml 600 will generate a prescribed or pre-programmed visual display pattern or display patterns through the plurality of display elements 62a-62f. The display elements 62a-62f can include appropriate light emitting diodes, such as blue LEDs, white LEDs, EL panels, EL tubes and etc.

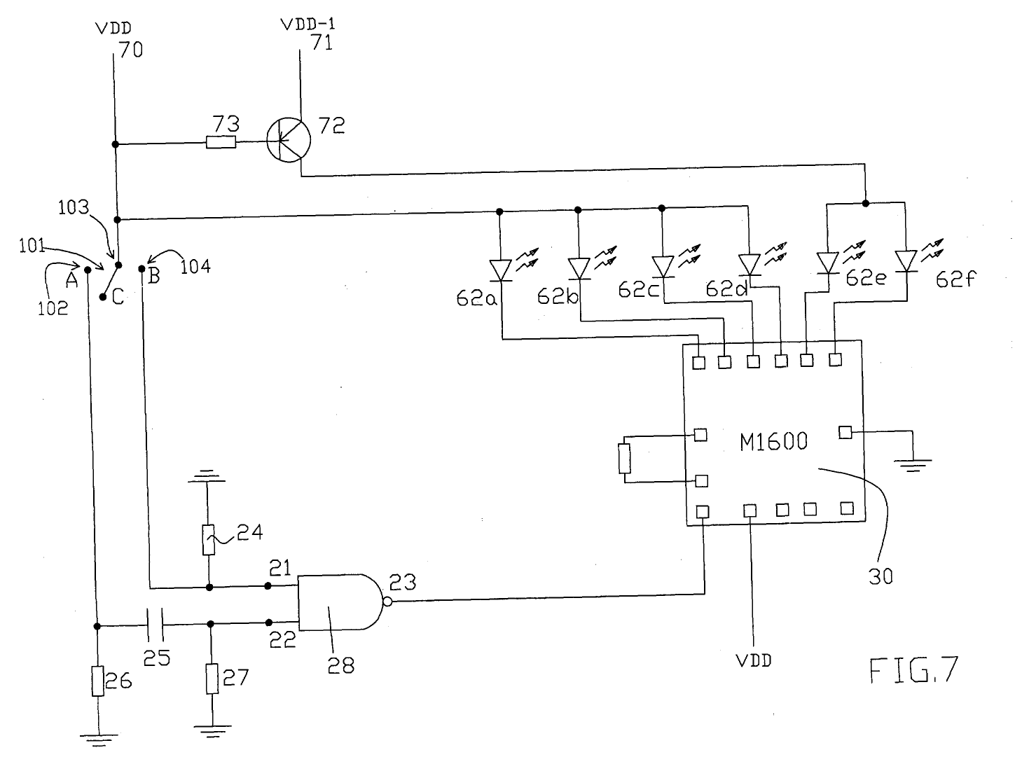

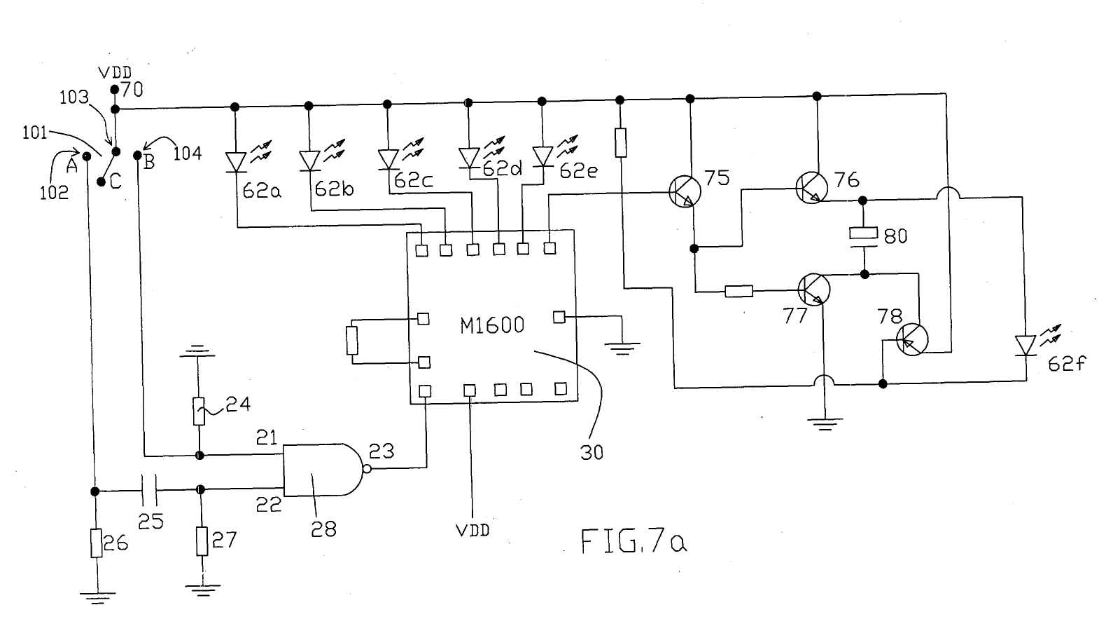

Referring to FIG. 7, there is shown another preferred embodiment of circuit arrangement which is generally identical to that of FIG. 1 but with slight variations. Referring to FIG. 7, it will be noted that the light emitting elements 62e and 62f are connected to the power source 71 via a transistor 72, the base of the transistor 72 is connected to the first power source 70 via a resistor 73. Two power sources 70, 71 are used in the present embodiment so that light emitting diodes of different voltage requirements can be respectively connected to the appropriate power supply. For example, low-voltage light emitting diodes 62a-d can be connected to the power supply 70 while light emitting diodes requiring a higher voltage supply can be connected to the additional power supply 71. The additional circuit arrangement comprising the resistor 73 and the transistor 72 will ensure that there will be no current supply to the high voltage light emitting diodes 62e and f when the supply voltage of the power source 71 drops below a certain level. Hence, current will flow into the LEDs 62e-f when the voltage at the power source 71 exceeds the voltage of power source 70 by at least the emitter base terminal threshold voltage of the transistor 72.

Referring to FIG. 7a, there is shown another circuit arrangement with a single power source which is configured and includes a voltage booster circuit for driving light emitting elements of different operating voltages. In this preferred embodiment, the light emitting diode 62f requires a higher driving voltage than the other diodes 62a-62e. The voltage booster circuit includes transistors 75, 76, 77 and 78 and a capacitor 80. Referring to the voltage boosting circuit included in FIG. 7a, when the base terminal of transistor 75 is high, then transistors 76, 77 and 78 will conduct and the electrolytic capacitor 80 will be charged up from the positive terminal of the power source which his a battery. When the base terminal of transistor 75 is next pulled low, transistor 78 will conduct. Current then flows from the positive terminal of the battery (VDD) through the collector-emitter terminals of the transistor and then to the negative terminal of the capacitor 80. As a result, the capacitor 80 is discharged, thereby providing an additional voltage necessary for driving the high voltage LED 62f. This arrangement achieves the provision of an additional, higher-voltage source than the power supply VDD without requiring an additional battery.

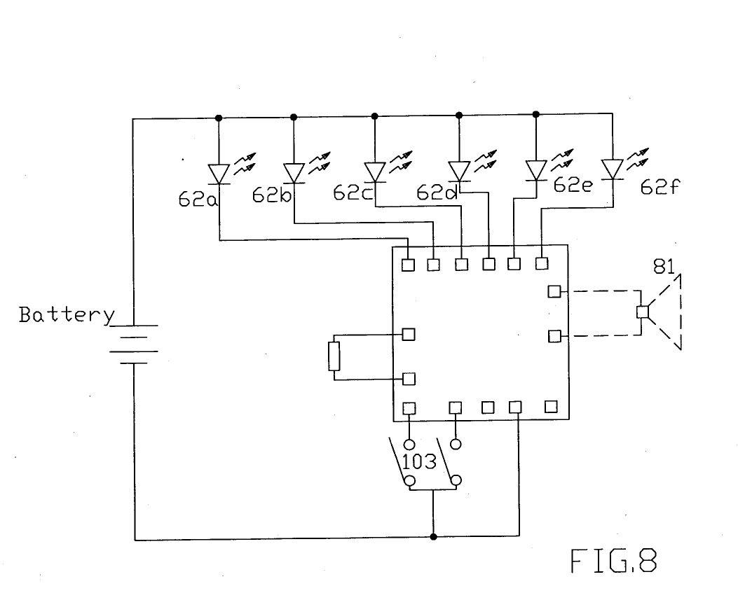

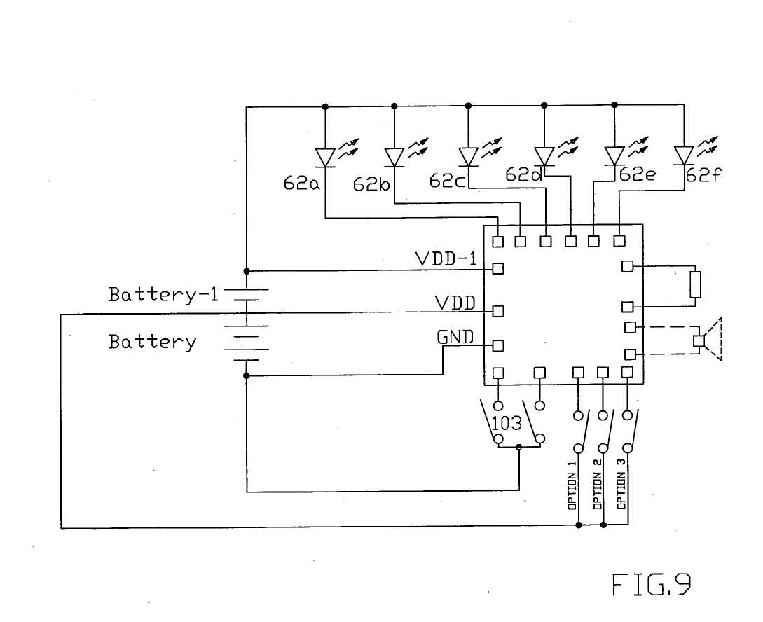

Referring to FIG. 8, there is shown a schematic circuit diagram of that of FIG. 1 and including an additional sound generating means 81, such as a speaker, for sound generating. The circuit diagram of FIG. 9 shows an equivalent circuit diagram of FIG. 7 including sound generating means.

While the present invention has been explained by reference to the preferred embodiments described above, it will be appreciated that the embodiments are only illustrated as examples to assist understanding of the present invention and are not meant to be restrictive on its scope. In particular, the scope, ambit and spirit of this invention are meant to include the general principles of this invention as inferred or exemplified by the embodiments described above. More particularly, variations or modifications which are obvious or trivial to persons skilled in the art, as well as improvements made on the basis of the present invention, should be considered as falling within the scope and boundary of the present invention.

Furthermore, while the present invention has been explained by reference to a shoe incorporating light pattern generating circuitry, it should be appreciated that the invention can apply, whether with or without modifications, to other articles without loss of generality.

1. A circuit arrangement including a contact switch, a motion dependent switching means and motion detection means, said contact switch being alternatively movable between a first switching position and a second switching position corresponding to the alternative first and second making (or breaking) positions, said motion detection means include means to generate an actuation signal when said motion dependent switching means moves between said first and said second switching positions according to a first predetermined sequence and within a first predetermined time.

2. A circuit arrangement of claim 1, wherein said motion detection means include means for retaining the immediately past switching status of one of said switching positions for a second predetermined time, said second determined time being equal or larger than said first predetermined time.

3. A circuit arrangement of claim 1, wherein said motion detection means further include comparison means to compare said stored immediately part switching status of said one of said contact switches with the immediately next switching status of the other contact switch, said comparison means generates an actuation signal when said immediately past switching status of said one of said contact switch and said immediately next switching status of the other contact switch fulfil a predetermined relative relationship.

4. A circuit arrangement of claim 1, wherein said motion detection means includes a NAND gate with one of its input terminals connected to said first switching position and another of its input terminals connected to said second switching position, a capacitive means being connected intermediate between said second input terminal of said NAND gate and said second switching position of said contact switch.

5. A circuit arrangement of claim 4, wherein the output of said NAND gate is connected to an electronic light pattern generating means which includes a plurality of outputs pre-programmed to give a pre-determined sequence of lighting patterns.

6. A circuit arrangement of claim 1, wherein said motion dependent switching means includes first, second and third contact terminals and a movable switching member, said movable switching member can provide conductive bridging either over said first and second or said second and third contact terminals, thereby respectively forming said first and second switching positions.

7. A circuit arrangement of claim 6, wherein said movable switching member includes a conductive sphere movable between said first and second switching positions.

8. A circuit arrangement of claim 6, wherein said movable switching member includes a conductive cylindrical rod movable between said first and second switching positions.

9. A circuit arrangement of claim 1, wherein said motion dependent switching means include a cantilever-type switching member which is under spring bias in said first or said second switching positions.

10. A circuit arrangement of claim 1, further including a visual display means, said visual display means include a plurality of light emitting diodes of a first and a second, higher, operating voltage and said second operating voltage being provided by a charged capacitor in addition to a common power source.

11. A circuit arrangement of claim 1, further including a transparent flexible panel with at least a receptacle for receiving at least one visual display means.

12. A circuit arrangement of claim 11, wherein said transparent flexible panel include a surface on which there are engraved figures, patterns or lines formed by carbon dioxide laser.

13. A circuit arrangement of claim 12, wherein said engraved areas include grooves having edges which are substantially perpendicular to the transparent flexible panel surfaces for light reflection.

14. A circuit arrangement of claim 13, wherein said transparent flexible panel being attached to the outer wall of the shoe.

15. An article including a circuit arrangement of claim 1.

16. An article of claim 15, wherein said article includes a shoe.

17. An article including the circuit arrangement of claim 2.

18. An article of claim 17, wherein said article includes a shoe.

19. An article including the circuit arrangement of claim 3.

20. An article of claim 19, wherein said article includes a shoe.
